(19) United States
(12) Patent Application Publication
(10) Pub. No.: US 2017/0244692 A1
(43) Pub. Date: Aug. 24, 2017

(54) AUTHENTICATION OF A USER USING A SECURITY DEVICE

(71) Applicants: Gemalto Inc., Austin, TX (US); Valimo Wireless Oy, Vanda (FI)

(72) Inventors: Sridhar BHUPATHIRAJU, Vanda (FI); Benoit FAMECHON, Austin, TX (US); HongQian Karen LU, Austin, TX (US); Asad Mahboob ALI, Austin, TX (US)

(73) Assignees: Gemalto Inc., Austin, TX (US); Valimo Wireless Oy, Vanda (FI)

(21) Appl. No.: 15/052,700

(22) Filed: Feb. 24, 2016

(51) Int. Cl. H04L 29/06

(52) U.S. Cl. CPC H04L 63/083; H04L 63/061; H04L 63/0876

(57) ABSTRACT

A mechanism for using a mobile device connected to a security device to authenticate a user to a service provider using a security device operating according to an applet without storing keys or user interface text on the security device or the mobile device. Registration and authentication messages to the mobile device are routed to a security device. These messages include a nonce. The security device encrypts responses from the user using the nonce and transmits an encrypted response message including the encrypted response to the authentication server, wherein the nonce is unique for each communication between the authentication server and the security device. Other systems and methods are disclosed.

### BACKGROUND OF THE INVENTION

The present invention relates generally to user authentication, and more particularly to a secure mechanism for authenticating a user using a security device.

In the brief history of mobile communications devices, the devices have quickly evolved from being primarily or even exclusively dedicated to mobile telephone communication to being extraordinarily powerful multi-purpose devices. With recent technical developments it is now possible to use mobile devices, e.g., mobile telephones, for disparate applications such as payment, transportation ticketing, loyalty programs, bank account access, access control for physical access to buildings or offices, etc. A consequence of the versatility of mobile devices is that mobile computing is becoming an increasingly important tool in the digital identity landscape, partly because of the personal nature of the mobile devices as users increasingly consider their mobile phone and mobile number as identity attributes, and partly because of the unique technological characteristics of mobile devices.

SIM cards connected to mobile devices provide secure network connectivity to mobile devices; as such SIM cards represent some of the most sophisticated security technology available. Furthermore, Mobile Network Operators (MNOs) are very experienced with registering customers, managing data, and developing fraud detection and prevention tools. It is desirable to make use of these complementary technologies in the domain of providing user identity and authentication.

One current technology for using a mobile device as an identity document is the GSMA Mobile Connect technology (GSM Association, headquartered in London, UK), which enables MNOs to act as Identity Providers (IdPs) so that users can authenticate to Service Providers (SPs) using their mobile devices. GSMA Mobile Connect is described at https://developer.mobileconnect.io/docs_overview (accessed on Dec. 16, 2015). Typically GSMA member companies, such as Gemalto S. A., headquartered in Amsterdam, The Netherlands, implement Mobile Connect on both the identity provider (IdP) side and the mobile device side. On the mobile device, Mobile Connect relies on the SIM that is connected to the mobile device and there is a SIM Applet, which executes on the SIM to support the Mobile Connect authentication protocol.

Unfortunately, hitherto the adopted architectures and protocols for Mobile Connect are burdensome in at least two regards, affecting both development and deployment costs, namely: a heavy registration and provisioning process and a large footprint for the Mobile Connect Authentication SIM Applet. (Herein, the term “applet” or “the applet” is used as shorthand for a SIM applet that provides registration and authentication services on behalf of a user using a mobile device.)

Heavy Registration and Provisioning Process.

Registration of a mobile device as an authentication device is typically a very involved process due to the various activities involved, such as language setting and establishment of a shared One-Time-Password (OTP) seed. For example, Gemalto's OCRA (OATH-OCRA is described in D. M'Raihi, OCRA: OATH Challenge-Response Algorithm, Internet Engineering Task Force (IETF) Request for Comments: 6287, (2011)) implementation requires 13 distinct GSM SMS messages in order to complete registration. Such a heavy registration process demands significant resource usage, which can be difficult to attain, for example, in areas with low bandwidth.

High Applet Footprint.

Current applets used in UICCs in conjunction with mobile devices to provide identity services have a very large applet footprint. For example, for a level of assurance (LoA) of 2 or 3, OATH OCRA applet size is approximately 12 KB; for a 3DES (Digital Encryption Standard) the applet size is approximately 8 KB. For a more complex level of assurance the applet size is even larger, such as with LoA 4, which typically requires an applet size of approximately 50 KB. Level of assurance refers to the degree of certainty associated with an identity assertion made by an identity provider by presenting an identity credential to a relying party (RP), e.g., a service provider. The levels of assurance (LoA) as used herein are defined by GSMA Mobile Connect Specification, and should not be confused with LoA defined by National Institute of Standards and Technology (NIST).

Complex applets and their correspondingly large applet footprints present several problems:
Require large and expensive UICCs
Require substantial development efforts and higher costs
Large applets are difficult to download to a UICC using over-the-air (OTA) provisioning protocols for UICCs. Even applets as small as 5K can be too large for achieving a practical download time in geographic areas with low network bandwidth.

From the foregoing it will be apparent that there is still a need for an improved method to provide a flexible, convenient and yet powerful mechanism to provide for reliable identity authentication using a mobile device and a security device associated therewith while both streamlining the registration and provisioning process and also minimizing the footprint of the applet executing on the security device.

### BRIEF DESCRIPTION OF THE DRAWINGS

FIG. 1 is a high-level schematic illustrating networks in which a mobile device having a security device connected thereto may be used to authenticate a user to a service provider.

FIG. 2 is a block diagram illustrating hardware components of a security device of FIG. 1.

FIG. 3 is a block diagram illustrating exemplary software modules and data that may be stored in memory of the security device of FIGS. 1 and 2 including an applet used to control the security device to provide authentication services.

FIG. 4 is a timing-sequence diagram illustrating the message flow that takes place between the nodes of FIG. 1 and the processing of such messages for the process of registering a mobile device for use as an identity and authentication device, for authenticating a user to a service provider.

FIG. 5 is a diagram illustrating the user interface displayed to a user for registering the mobile device of the user for use with a service provider.

FIG. 6 is a timing-sequence diagram illustrating message flow when a user is not required to enter a PIN during authentication using a mobile device.

FIG. 7 is a diagram illustrating the user interface displayed to a user for authenticating the user to a service provider using a mobile device of the user.

FIG. 8 is a timing-sequence diagram illustrating message flow when a user is required to enter a PIN during authentication using a mobile device.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment of the invention, a technology is presented that provides a mechanism by which a security device, e.g., a universal integrated circuit card (UICC) such as a GSM subscriber identity module (SIM) card, may be used to secure provisioning of identity of a user using a mobile device in a secure and efficient manner which requires a UICC applet having a relatively small footprint. The presented mechanism allows for such applets to be developed that may be readily downloaded or installed in a UICC in a fashion in which the applet is ready for immediate use in registering a mobile device into a system in which a mobile network operator may act as an identity provider such that users may use their mobile device as an authentication medium for access to service provider services.

Conceptually, the technology presented herein reduces and simplifies the activities that the identity applet of the security device performs, transferring some activities to the server side, e.g., to an authentication server, while maintaining the security device connected to the mobile device as a security enabler. In one embodiment, user interaction and security level is maintained consistent with existing SIM-based user authentication, i.e., at LoA 2 and 3 as defined in the GSMA Mobile Connect Specification.

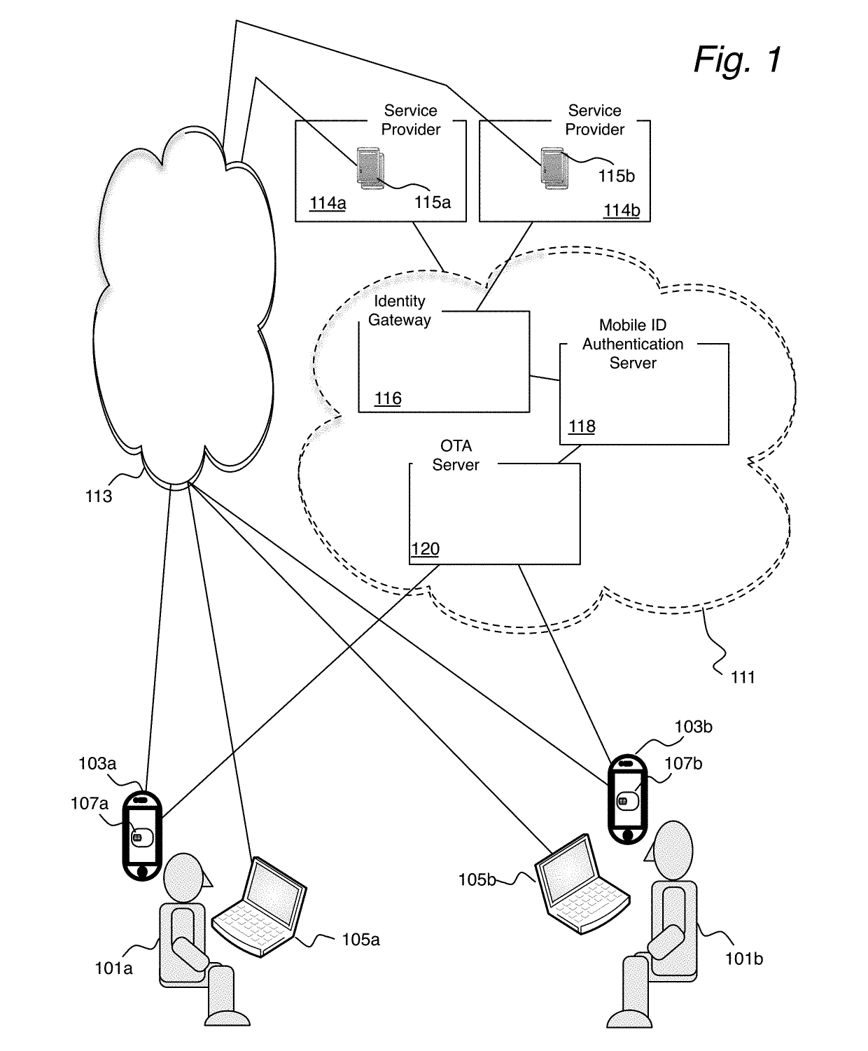

FIG. 1 is a schematic illustration of a computer network 113, e.g., the Internet, connecting personal computers 105a and 105b, operated by users 101a and 101b, respectively, to one or more remote service provider (SP) servers 115a and 115b, operated by service providers 114a and 114b, respectively. Henceforth herein, where the “service provider” is referred to as performing a task, unless explicitly stated otherwise, generally such a task should be interpreted to be performed by a computer operated by a service provider, e.g., a service provider server 115 acting under instructions of some computer code often referred to as server software.

The SPs 114 may provide any of a myriad of possible services. Typical examples include online banking, online commerce, online instruction, online voting, etc. As a reader hereof appreciates, in these examples transaction security is extremely important.

A user 101 operates a user computer 105 to interact with one of the SP servers 115 over the network 113. Such interactions are advantageously performed using general-purpose web browser programs downloaded to the computer 105. Such web browser programs may execute particular web applications during interactions between the web browser and server software of the service provider 115.

A user 101 may also interact with service providers 115 using mobile device 103. Such interaction may also be via general-purpose web browsers. However, more common interaction between a user 101 using a mobile device 103 and a service provider 115 is by way of special purpose applications, also known as apps, that provide the user with a feature rich environment through which the user 101 interacts with server applications.

As discussed herein above, an aspect of interaction between a user 101 and a service provider 115 is provisioning of the identity of the user 101 to the service provider 115 using the mobile device 103. This interaction includes the secure authentication of the provided user identity using a security device 107 connected to the mobile device 103. As described herein above, GSMA Mobile Connect provides an example of such technology.

When a user 101 seeks to interact with a service provider 115, the user 101 may be identified using the user's mobile device 103 through the network 111 of a mobile network operator (MNO). Indeed, the network 111 may connect to other mobile networks and to the publically switched telephone network (PSTN). Network 111 should be considered to include all such alternatives. However, for the sake of a streamlined presentation of the technology, the technology is described as if the service providers and user mobile device 103 are connected to one network 111.

The network 111 contains three principal nodes according to a preferred embodiment:
An identity gateway 116, which receives authentication requests from service providers 115 and provides the service providers with authentication status responses to such authentication requests
A mobile identity authentication server 118, which receives authentication requests from the identity gateway 116 and interacts with a user 101 via the user's mobile device 103 and the security device 107 connected thereto to register the mobile device 103 for identity purposes and to authenticate any attempts of using the mobile device to identify the user 101 to the service provider 114
An Over-the-Air (OTA) server 120 which provides interaction between the authentication server 118 and the mobile device 103 as well as with the security device 107

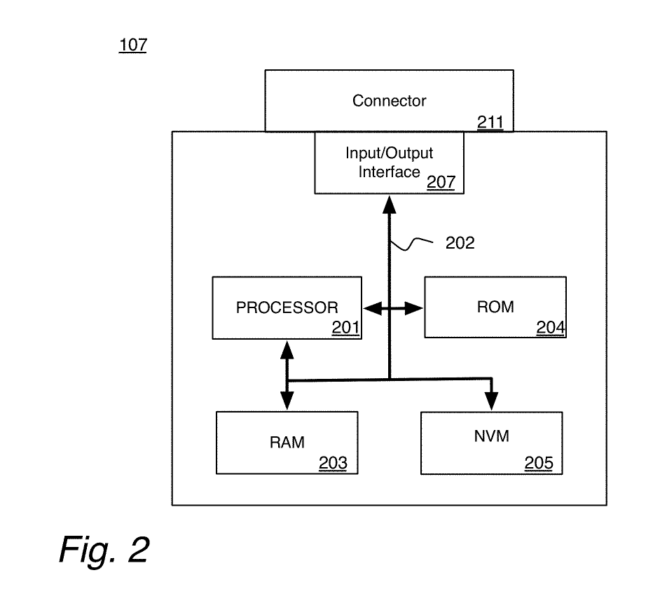

FIG. 2 is a schematic illustration of a security device 107. The security device 107 may include a processor 201 connected via a bus 202 to a random access memory (RAM) 203, a read-only memory (ROM) 204, and a non-volatile memory (NVM) 205. The security device 107 further includes an input/output interface 207 for connecting the processor 201, again typically via the bus 202, to a connector 211 by which the security device 107 may be connected to a host mobile device 103.

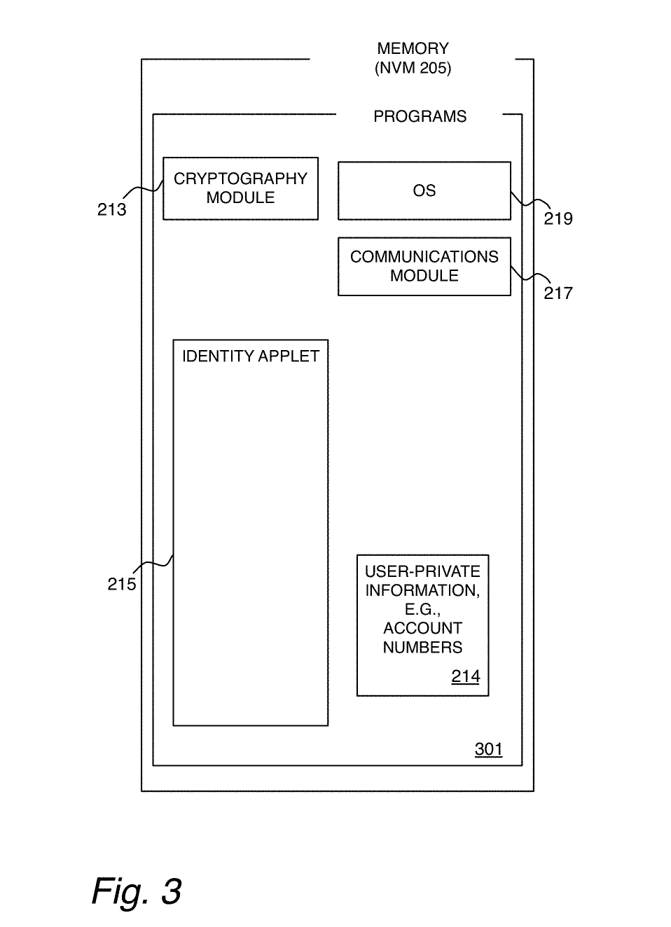

The NVM 205 may include computer programs 301 as is illustrated in FIG. 3. While it is here depicted that the computer programs 301 are all co-located in the NVM 205, in actual practice there is no such restriction as programs may be spread out over multiple memories and even temporarily installed in RAM 203. Furthermore, the security device 107 may include multiple ROMs or NVMs. The programs 301 include operating system programs as well as application programs loaded on to the security device 107. The NVM 205 of the security device 107 may also contain private data 214, such as account numbers.

The security device 107 programs 301 may include a cryptography module 213, a communications module 217, and the operating system OS 219.

As discussed herein above, an identity applet 215, executing on the security device 107, is used to receive secure registration and authentication requests from the authentication server 118 and create responses for these request to the authentication server 118.

The server-side, e.g., the authentication server 118, is the principal actor in the mechanism. The identity applet of the security device complements the server-side by managing interaction with the user 101 and performing required security tasks. For example,
PIN Management. In one embodiment, the authentication server 118 maintains user PINs (more accurately, a hash of the PINs). The security device identity applet 215 interacts with the user 101 to allow the user 101 to set the PIN that is to be used to authenticate the mobile device 103 for use with the service provider 115.
UI (User Interface) Texts. All UI texts are stored on the authentication server 118 and provided to the applet 215 for display to the user 101.
Application Security. Transport keys for sending responses are not stored by the applet 215 on the security device 107. Rather the applet 215 uses a key or a derivative of a key, as described herein below, based on information provided by the authentication server 118. This information may be a nonce and responses may be encrypted using a key derived from that nonce.

Security of requests transmitted from the authentication server 118 to the security device 107 is ensured using 03.48 OTA Security.

Registration of a Mobile Device for Use as an Identity and Authentication Device

There are two principal phases to the use of a mobile device 103 as an identity and authentication device for use with a service provider 115: the registration phase in which a user registers the mobile device 103 with an authentication server 118 and the authentication phase in which the user confirms to the authentication server 118 an attempted use of the mobile device 103 to authenticate to a service provider 115.

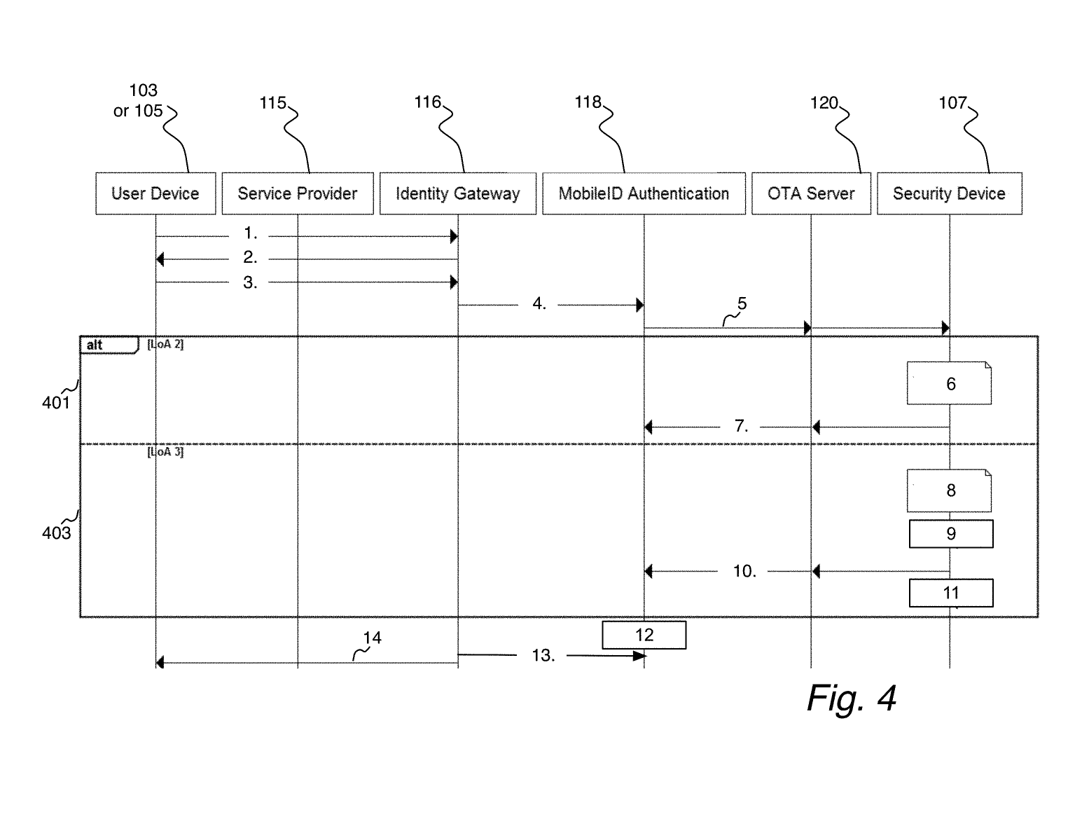

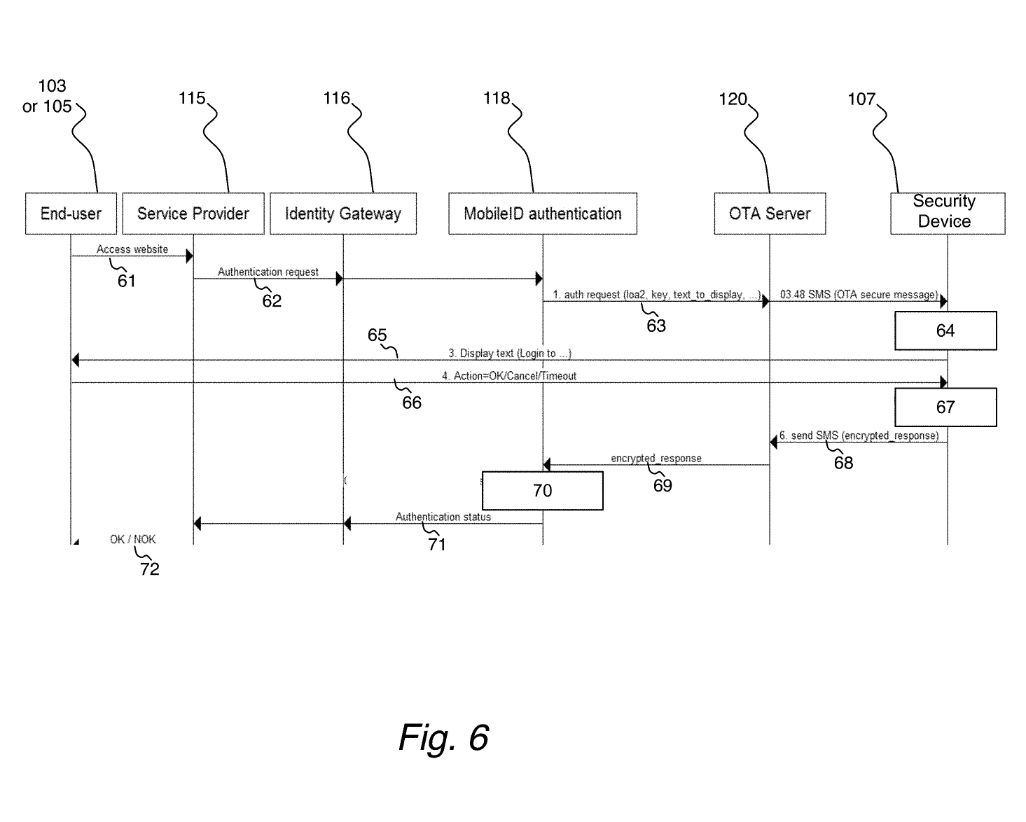

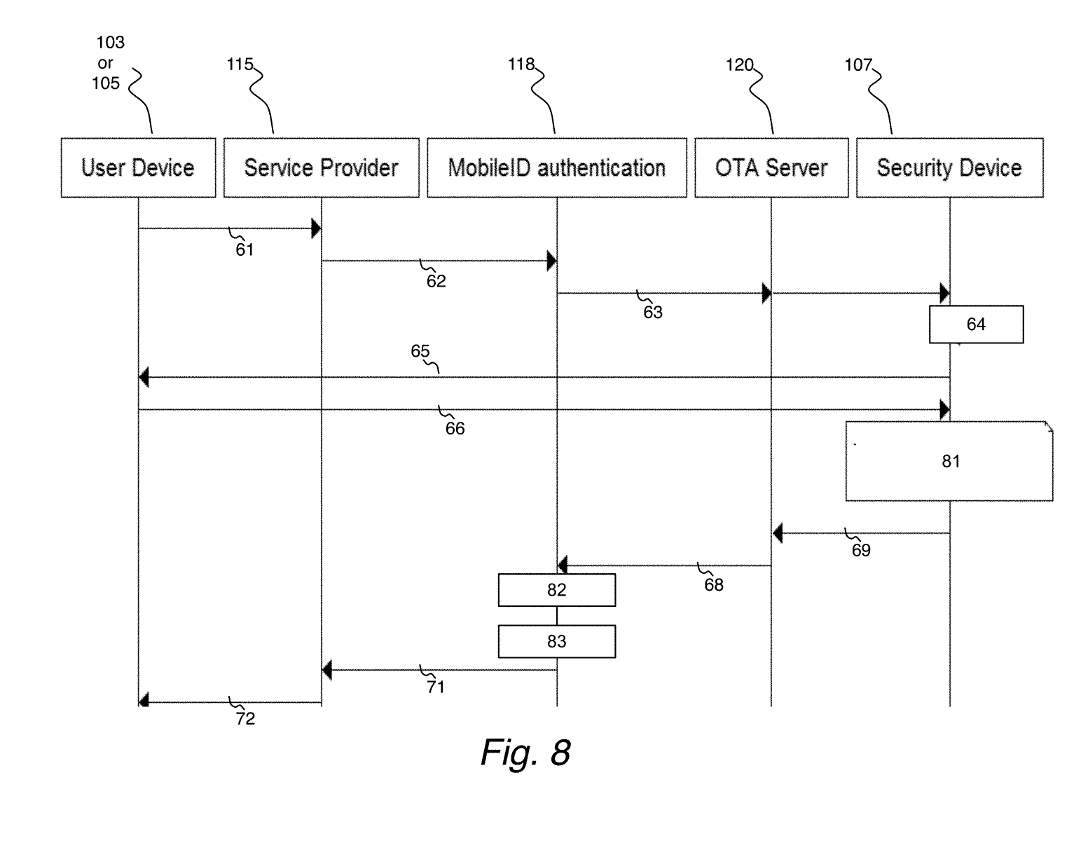

Turning first to the registration phase. FIG. 4 is a timing-sequence diagram illustrating the message flow that takes place between the nodes described herein above during a registration process and the processing of such messages to register a mobile device for use as an identity and authentication device for authenticating a user to a service provider 115 according to one embodiment. Corresponding authentication processes are illustrated in FIGS. 6 and 8.

A user 101 seeks to register the user's mobile device 103 for authentication to the service provider 115. The user causes either the mobile device 103 or the computer 105 of the user to start the registration process by sending a registration message to the identity gateway 116, step 1, optionally through the service provider 115.

The identity gateway 116 responds by requesting the user to enter an identifier, e.g., the MSISDN of the user's mobile telephone or an alternate identifier, step 2.

The user 101 enters the MSISDN or alternate identifier on whichever device the user is using to interact with the identity gateway 116, e.g., on the host computer 105, step 3, and that response is transmitted to the identity gateway 116.

The identity gateway 116 forwards the identifier to the authentication server 118, step 4.

In an alternative embodiment the identity gateway 116 and the authentication server 118 are merged.

The authentication server 118 builds and transmits a registration authentication request to the security device 107 via the OTA server 120 to verify the mobile device 103, step 5. For LoA 2, the registration authentication request merely requires the user 101 to acknowledge and OK the registration request. For LoA 3, the user 101 is requested to enter a PIN that is to be used in future authentication activities wherein the mobile device 103 is used to authenticate a user to the service provider 115. The registration authentication request includes transaction ID, LoA, user interface text to be displayed to the user 101 on the mobile device 103 and a nonce that is used either as a key for the response sent back to the authentication server 118 or from which a key is derived. The registration authentication request message may contain a salt to be used by the applet 215 executing on the security device 107 to compute a salted hash of the PIN which is included in the response message that the security device 107 transmits back to the authentication server 118. In yet another alternative embodiment, the registration authentication request message may contain a pepper, e.g., an iteration number.

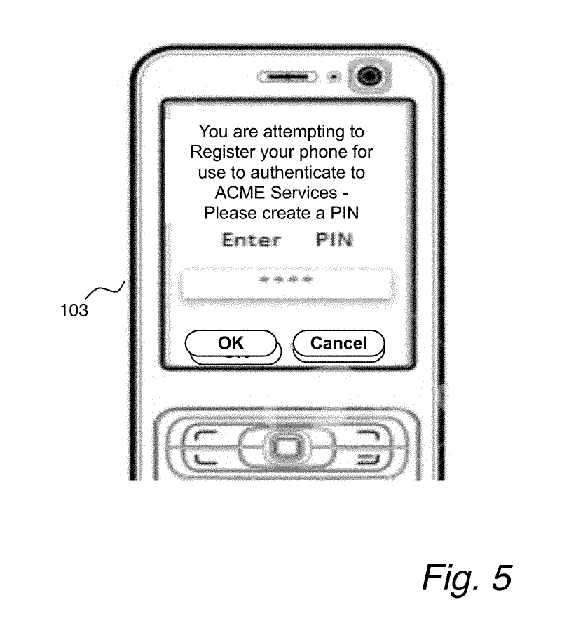

Upon receiving the registration authentication request (step 5), the security device 107 causes the user interface text to be displayed on the mobile device 103. FIG. 5 is an example of the text, which might be displayed, for the case of LoA 3, which requires the user to create and enter a PIN. The displayed text, as well as user interface elements such text entry fields, are provided in the registration authentication request message.

For the LoA 2 case 401, the user 101 clicks “OK” or “Cancel” on the mobile device 103 in response to the security device 107 and the security device 107 creates a response message based on the user input, step 6. The security device 107 encrypts the response message using the nonce from the registration authentication request. The nonce can either be used directly, or a derivation can be performed on the nonce to generate the cryptographic key used in encrypting the response.

The security device 107 transmits the response back to the authentication server 118, step 7.

For the LoA 3 case 403, the user is required to create a PIN. The user 101 may be required to enter the PIN twice and check that both are the same, step 8.

The security device 107 computes a salted crypto hash from the PIN using either a salt (a random data) sent by the server or, if no salt, using the nonce (or a portion of the nonce) sent by the server as a salt, resulting in H=saltedhash (PIN,salt), step 9. If the registration authentication request message contains a pepper (another random data), the salted hash of the PIN is computed using both the salt and the pepper. The applet constructs a response, which includes H and any other data required for a response and encrypts the response directly or indirectly using the nonce as a key, step 10. The encryption key may be derived from the nonce.

The security device 107 deletes the PIN, the user interface text, etc., step 11.

In response to receiving the registration request response, either response 7 or response 10, the authentication server 118 decrypts the response using the nonce (or using a key derived from the nonce) and records the response, i.e., either recording that the user has acknowledged and acquiesced to the use of the mobile device as an authentication device, has not acquiesced to such use, or records the salted hash of the PIN if the LoA requires a PIN entry by the user and the salt, step 12. In the alternative embodiment that also includes a pepper, the authentication server 118 also stores the pepper so that it may be communicated to the security device 107 during subsequent authentication verification steps.

As is discussed herein below in the discussion of the authentication phase, because the authentication server 118 knows the salt as well as the salted hash of the PIN, in one embodiment, the subsequent authentication request responses is encrypted by the security device 107 using a key that is derived from the nonce coming with the authentication request and the salted hash of the PIN. The authentication server 118 may then derive the same key as the one generated by the secure device 107 and decrypt the response. The response itself does not need to contain the PIN nor the salted hash of the PIN.

Subsequently, the identity gateway 116 may send a query to and receive a response from the authentication server about the registration status of the mobile device, step 13, and the identity gateway 116 informs the user device to inform the user the status of the registration, step 14, e.g., “Your device has been registered for use as an authentication device with service provider XYZ,” step 14.

Thus, at the conclusion of the process of FIG. 4, a mobile device 103 has been registered for use as an authentication device with the service provider 115 unless the user opted to not confirm the registration attempt by clicking on “cancel,” thereby cancelling the interaction. Further, if the registration request message specified LoA 3, the user created a PIN, and thus, the authentication server 118 stores a salted hash of the PIN as well as any salt and pepper used in computing the salted hash.

In a first alternative embodiment, the authentication server 118 applies additional hashing (with salt or pepper) on top of PIN Hash received in response. In this embodiment, the authentication server 118 stores the resultant hash along with the salts or peppers involved. In this embodiment, the authentication server 118 derives the encryption key for authentication messages from the nonce.

In a second alternative embodiment, the PIN is managed on the security device 107, for example, by the identity applet 215. In this case, the PIN is stored locally by on the security device 107 and the PIN data is not sent in the registration response of Step 10. Of course, in that embodiment, the PIN is not deleted by the identity applet 215 as discussed herein above.

Authentication of an Attempt to Use the Mobile Device as an Authentication Device.

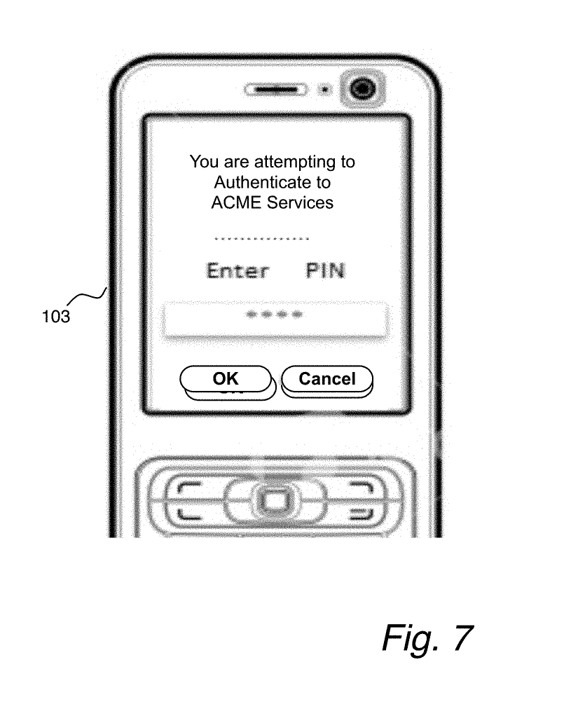

Turning now to the use of the mobile device 103 as an authentication device when a user seeks to access services provided by a service provider 115. If the mobile device 103 of the user has affirmed the registration, and, in the case of LoA 3, created a PIN, the mobile device 103 may be used as an authentication device for authenticating the user 101 to the service provider 115. FIG. 6 is a timing sequence diagram illustrating the message flow for the LoA 2 case, FIG. 7 illustrates the user interface displayed on the mobile device 103 for authentication to a service provider under LoA 3 (PIN required), and FIG. 8 is a timing sequence diagram illustrating the message flow for the LoA 3 case.

Consider the LoA 2 case wherein the authentication is merely acknowledged by the user 101 on the mobile device 103. A user 101 operating a user device 105 (note that if the user device is the mobile device 103, a case that is included herein as if mobile device 103 serves both as a user device 105 on which an interaction with a service provider 115 takes place as well as a mobile device 103 used for authenticating the service provider 115) uses a web browser program on the user device 105 to access a service provider web site on the service provider server 115, step 61.

The service provider 115 requires user authentication of the user 101 and transmits an authentication request to the authentication server 118 via the identity gateway 116, step 62.

The authentication server 118 builds an authentication request and transmits it to the security device 107 via the OTA server 120, step 63. The authentication request contains: a transaction ID, specification of required LoA, a nonce, and user interface text to be displayed to the user 101 on the mobile device 103 and an indication to the mobile device indicating which actions the user may take, e.g., “OK”, “Cancel”, “Yes”, “No”. The nonce is used in conjunction with the user's response to derive a key used to encrypt a response from the security device 107. In a preferred embodiment the authentication request is transmitted securely using OTA secure transport, e.g., using secure SMS messages.

The security device 107 receives the authentication request message and verifies the request, step 64. The security device 107 decrypts the OTA message and forwards the message to the applet 215. The applet validates the request.

The user interface text and UI elements are displayed on the mobile device 103, step 65. FIG. 7 illustrates an exemplary user interface on the mobile device 103 including user-interface text received from the authentication server 118 in the authentication request message. Note, the example in FIG. 7 is applicable to LoA 3 (PIN required) whereas the flow of FIG. 6 applies to LoA 2. Thus, typically for LoA 2, the user interface would not contemplate a PIN entry but would provide a user 101 with the option to accept the authentication request or to decline it, e.g., “Click ‘OK’ to authenticate, ‘Cancel’ to abort.”

The user 101 enters a response, which is transmitted back to the security device 107, specifically, the applet 215, step 66.

Having received the user response, for an LoA 2 case, the user's response is encrypted using a key derived from the nonce provided by the server in the authentication request message and the user response, step 67. The response would contain: a) the transaction id received in the request; b) the status code pertaining to the user action. In case the User Action is “OK”, the text displayed can also be included.

The encrypted response is transmitted back to the authentication server 118, for example, using an SMS message to the OTA server 120, step 68, which forwards it to the authentication server 118, step 69.

The authentication server 118 decrypts the received response and verifies the user action by the status code, step 70. As the message is encrypted using a key derived from the nonce sent in the authentication request message as well as the user response, a correct decryption that results in a verifiable transaction ID and an appropriate status code may be used to confirm that the response was created by the security device 107 in response to the authentication server 118. The nonce acts as a one-time-key. Only responses that are encrypted in response to new authentication request messages will be accepted as verified authentication acknowledgement from the user 101 operating the mobile device 103. By deriving possible keys from the various possible user responses (together with the nonce), the authentication server 118 determines which user response was provided by the user.

Note that while it is preferable to use the nonce together with the user response to derive the encryption key for the response message, in an alternative embodiment, only the nonce is used to derive the encryption key or, in yet another alternative, the nonce is used directly as an encryption key.

The authentication status may be transmitted to the service provider 115, step 71, which forwards a status to the user 101 on the web browser application on the user device 105, step 72.

FIG. 8 is a timing sequence diagram illustrating the authentication process under LoA 3 (PIN required). The flow is much the same as the flow in FIG. 6 and only steps that differ from those in FIG. 6 are discussed here. Note also that FIG. 8 illustrates another variation, namely, that there are many possible configurations as to the combination of servers used. Here, for example, the identity gateway 116 is not specifically set out. Rather, the authentication server 118 takes on the functionality of both the identity gateway 116 and the authentication server 118 of FIG. 6.

Steps 61 through 64 are analogous to the same-numbered steps of FIG. 6. However, the authentication request message transmitted from authentication server 118 to the security device 107 specifies LoA 3 (PIN required) and provides user interface text requiring entry of a PIN, e.g., as indicated in FIG. 7.

As the flow of FIG. 8 is for the case where the user 101 is required to enter a PIN, the response is encrypted using a cryptographic key that is derived from the nonce and the PIN directly or indirectly. For example, the cryptographic key may be derived from the nonce and a salted hash of the PIN. In one embodiment, the authentication request message includes the salt to be used to compute the salted hash. In other embodiments, the salt may be a predefined subset of the nonce or any other quantity that is known to change but that both the authentication server 118 and the security device 107 can determine independently.

Steps 65 and 66 are also analogous to the like-numbered steps of FIG. 6. However, the user 101 (unless the user cancels the authentication) enters a PIN on the mobile device 103. The response message, step 66, is encrypted using a key derived from the nonce or from the nonce and the user PIN. In a preferred embodiment, the user's agreement to authenticate using the mobile device 103 is encrypted using a cryptographic key that is derived from the nonce and a PIN entered by the user. Note that the present description pertains to when the user responds to the authentication request by entering a PIN, thereby confirming the intent to authenticate to the service provider 115. If the user cancels or the interaction times out, the response flow is somewhat different.

Continuing with FIG. 8, the security device 107 receives the PIN from the user entry on the mobile device 103 and computes a response message, step 81. To compute the response message the applet 215 computes a salted hash of the PIN (H=saltedhash (PIN, salt)) using the salt received in the authentication request message, and then it derives an encryption key using the nonce received in the authentication request message and the salted hash (H). If the user 101 declines the authentication request, either by explicitly clicking on a “CANCEL” button or by timeout, the applet 215 derives the encryption key from the nonce alone. The response is prepared to include the transaction ID received in the authentication request message and the status code associated with the user's action (e.g., PIN entry, timeout, cancel). The response may also contain displayed text. The response is encrypted using the derived key.

In an alternative embodiment, a further integrity check is included in the response. The applet 215 computes a hash of the response, or of some relevant elements, e.g., the result of the operation (i.e., “OK”, “Cancel”, “Timeout”), a portion or the entire display text, or a hash of the PIN.

The response is transmitted back to the authentication server 118 via the OTA server 120, step 69, for example, in the form of an SMS message, step 68.

The authentication server 118 derives the key for the received message using the stored hash of the PIN and the nonce transmitted in the authentication request message, step 82. If the authentication server 118 is able to interpret the decrypted message that is an indication that the PIN was entered correctly as the derived keys must then match.

As the authentication server 118 does not know whether a PIN was entered or not, the authentication server 118 may need to try both a derived key from the salted hash of the PIN and from the nonce alone. Thus, if the authentication server 118 cannot interpret the response using a key it derives from the PIN and the salted hash, it attempts to decrypt the response message using a key derived from the nonce alone, which corresponds to the user 101 not having entered a PIN, step 83.

In the alternative embodiment, which includes an integrity check, the authentication server 118 verifies the integrity hash to confirm the integrity of the response.

If neither step 82 nor 83 result in a response that the authentication server 118 may interpret, the authentication attempt has failed. Similarly, if the response is decoded to correspond to a cancel or timeout, the authentication is declined.

The authentication server 118 responds to the service provider 115 with the authentication status, step 71, and the service provider 115 may notify the user of the user device 105 of the authentication status, step 72.

In an alternative embodiment, the PIN is established on the server side. During registration the user 101 sets the PIN at the server portal accessed using a web browser via the user device 105. The authentication server 118 stores the PIN safely. In this embodiment, during the registration process, the authentication server 118 transmits a verification request message to the mobile device 103, which forwards the verification request message to the security device 107. On the security device 107, the applet 215 verifies the PIN as follows:
The authentication server 118 provides a checksum or a hash of the PIN in the verification request message.
The applet 215 independently computes a checksum or a hash of the PIN entered by the user. The applet 215 then verifies the checksum or hash as being the same as that checksum or hash sent by the authentication server 118.
If checksum or hash does not verify as being the same, the applet 215 may prompt the user to enter the PIN again, for a reasonable number of attempts.
The PIN is used to compute the transport key together with the nonce provided by the server side.
Since the nonce and PIN are known by the authentication server 118, the authentication server 118 can decrypt and check the response from the security device 107 as computed by the applet 215.

For illustrative purposes, we describe the technology presented herein as it may be used in a mobile device 103. However, the technology presented is applicable to any programmable electronic device with a need for a secure trusted execution environment.

A number of advantages are achieved using the herein described technology. The technology improves the use of a mobile device having a security device connected thereto in that a security device applet used to provide security functionality in provisioning of identity and authentication of a user using a mobile device has a significantly smaller footprint than prior art applets. This advantage is achieved both by avoiding storage of a PIN on the security device and avoiding storage of user interaction prompts on the security device because PIN prompts are provided from the authentication server 118. Further, transport keys are not stored on the security device (other than OTA transport keys which are stored on the security device for other purposes) as the transport keys are derived from information provided by the authentication server 118 to the security device 107 during both the registration and authentication processes.

The provisioning of the applet 215 is robust because the applet 215 may be either preloaded on the security device 107 or readily downloaded without the need for personalization; the applet 215 is ready to use as soon as it is installed on the security device 107.

The registration and provisioning process is reduced to a single SMS message. Minimizing the number of SMS messages is a great advantage to end-users as the provisioning process can occur very quickly with a minimum of resource usage. That advantage likely produces a higher user acceptance of the process and end-users are likely to see a benefit in using their mobile device as an identity device rather than to see it as a hindrance to using service provider services. That, in turn, provides service providers an incentive to adopt mobile devices as optional or required identity devices for use with their services.

The herein described technology provides a high level of security, as no sensitive information is stored on the security device 107 to enable its use as a mobile identity device. Transport security for messages sent in both directions is at least as high as the security defined by 3DES encryption. Both mobile originated and mobile terminated messages are encrypted, which provides a higher level of security than conventional OTA secure transport.

Because the applet 215 is relatively small, the applet 215 may be download using OTA provisioning. This is a significant advantage in that mobile identity may be provided using a security device 107 to secure the authentication even on mobile devices for which the security device 107 is not pre-provisioned with an applet to provide the requisite functionality to secure mobile device identity and authentication.

While the technology described herein above is advantageously applied to the authentication of a mobile device 103 for use as an authentication device for authenticating a user 101 to a service provider 115, the technology also has other applications. For example, the mechanisms described herein may be advantageously used to obtain user confirmation of electronic transactions, i.e., to provide an out-of-band verification of a user. The technology may also be used to obtain consent of a user 101 to particular transactions that are attempted, for example, using a user device 105 interacting with a service provider 115.

From the foregoing it will be apparent that a technology has been presented that improves the mechanisms used to authenticate a user by a service provider through an identity provider and a security device in a mobile device.

Although specific embodiments of the invention have been described and illustrated, the invention is not to be limited to the specific forms or arrangements of parts so described and illustrated. The invention is limited only by the claims.

We claim:

1. A method for using a mobile device connected to a security device to authenticate a user to a service provider using a security device operating according to an applet without storing keys or user interface text on the security device or the mobile device, the method comprising authenticating the mobile device for authentication of a user to the service provider by transmitting an authentication request message including a nonce from the authentication server to the applet of the security device and encrypting a response from the user using a cryptographic key derived from the nonce and the user response, and transmitting the encrypted response message including the encrypted response to the authentication server, wherein the nonce is unique for each communication between the authentication server and the security device.

2. The method for using a mobile device connected to a security device to authenticate a user to a service provider using a security device operating according to an applet without storing keys or user interface text on the security device or the mobile device of claim 1, further comprising registering the mobile device for authentication of a user to the service provider by transmitting a registration request message to the applet of the security device and wherein a registration step comprises: upon receiving the registration request message, which includes a request for the user to define a personal identification number (PIN), generating by the applet a salted hash of the PIN for the user and including the salted hash of the PIN in the encrypted response message.

3. The method for using a mobile device connected to a security device to authenticate a user to a service provider using a security device operating according to an applet without storing keys or user interface text on the security device or the mobile device of claim 2 wherein the registration request message includes a salt from which the security device generates the salted hash of the PIN.

4. The method for using a mobile device connected to a security device to authenticate a user to a service provider using a security device operating according to an applet without storing keys or user interface text on the security device or the mobile device of claim 2, wherein the registration step further comprises storing the salted hash of the PIN on the authentication server, and an authentication step comprises receiving user entry of a PIN on the security device, operating the security device to transmit the salted hash to the authentication server in the encrypted response message, and operating the authentication server to verify the salted hash against the stored salted hash from the registration step.

5. The method for using a mobile device connected to a security device to authenticate a user to a service provider using a security device operating according to an applet without storing keys or user interface text on the security device or the mobile device of claim 4 further comprising operating the authentication server to store a salt used to compute the salted hash.

6. The method for using a mobile device connected to a security device to authenticate a user to a service provider using a security device operating according to an applet without storing keys or user interface text on the security device or the mobile device of claim 4 further comprising operating the security device to delete the PIN, the salted hash, and the nonce after sending the encrypted response message to the authentication server.

7. The method for using a mobile device connected to a security device to authenticate a user to a service provider using a security device operating according to an applet without storing keys or user interface text on the security device or the mobile device of claim 6 wherein the request message is an authentication request message requesting to use the mobile device to authenticate to a service provider and the authentication step further comprises transmitting in the authentication request message a quantity useable to pre-disqualify a PIN entry as not matching a correct PIN, and operating the security device, upon receiving a PIN entry, to verify that the entered PIN is not disqualified from being a valid PIN.

8. The method for using a mobile device connected to a security device to authenticate a user to a service provider using a security device operating according to an applet without storing keys or user interface text on the security device or the mobile device of claim 7 wherein the quantity useable to pre-disqualify a PIN entry is a checksum, a CRC, or a sub-set of the stored salted hash of the PIN entered on registration.

9. The method for using a mobile device connected to a security device to authenticate a user to a service provider using a security device operating according to an applet without storing keys or user interface text on the security device or the mobile device of claim 1 wherein the request message further comprises a display text and the method further comprises operating the security device to cause display of the display text on the mobile device.

10. A method for using a mobile device connected to a security device to authenticate a user to a service provider, the method comprising:
registering the mobile device for use in authentication to the service provider by:
sending a registration request and a mobile device identifier to a registration/authentication server;
sending an authentication request from the registration/authentication server to the security device of the mobile device, the authentication request including an nonce and user interface dialog text to the security device;
operating the security device to cause display of a user interface dialog including the user interface dialog text on the mobile device;
receiving user input indicating a user response to the user interface dialog text;
if the user input indicating a user response includes a confirmation of registration, transmitting an encrypted registration response from the security device to the registration/authentication server indicating the user confirmation of registration, the encrypted registration response being encrypted using a cryptographic key derived from the nonce received from the registration/authentication server and the user response; and
storing a registration record indicting the user registration on the registration/authorization server; and
authenticating the mobile device to the service provider by:
upon a user accessing a website of the service provider, transmitting a first authentication request to the registration/authentication server;
upon receiving the first authentication request, transmitting a second authentication request from the authentication server to the security device, the second authentication request including a nonce and user interface text to confirm the authentication request,
operating the security device to cause the display of the user interface text on the mobile device and to obtain a user action in response to the authentication request;
sending the user action in an authentication response message from the security device to the authentication server as an encrypted message encrypted using a cryptographic key generated from the nonce and the user action;
attempting decryption of the authentication response message by the authentication server using a plurality of cryptographic keys generated from the nonce and acceptable user actions thereby determining the user action corresponding to a successful decryption of the user action message; and
transmitting an authentication status to the service provider server corresponding to a successful decryption of the user action message.

11. The method for using a mobile device connected to a security device to authenticate a user to a service provider of claim 10 wherein the first authentication request includes an indication of required level of assurance (LoA); and
wherein the registration step further comprises:
upon detecting a level of assurance requiring entry of a personal identification number (PIN), receiving a user entry of a PIN to be used upon authenticating the user using the mobile device;
computing a salted hash (H) of the PIN on the security device;
transmitting the salted hash (H) of the PIN to the authentication server in the encrypted message;
deleting the PIN, the salted hash (H) of the PIN, and the nonce;
after decrypting the registration response message on the authentication server, storing the salted hash (H) on the authentication server.

12. The method for using a mobile device connected to a security device to authenticate a user to a service provider of claim 11 wherein the first authentication request includes an indication of required level of assurance (LoA); and
wherein the authentication step further comprises:
wherein the user interface text includes a prompt for entry of the identification number (PIN);
receiving a user entry of the identification number (PIN);
computing a salted hash from the identification number (PIN);
deriving, on the security device, a key from information received in the authentication request and the salted hash of the identification number (PIN);
encrypting the authentication response message using the derived key and transmitting the encrypted authentication response message to the authentication server;
wherein in generating, on the authentication server, a plurality of candidate cryptographic keys, the acceptable user input from which the cryptographic keys are generated to determining the user action includes the identification number and wherein in generating said cryptographic keys, the acceptable user action is said identification number and the corresponding candidate is generated from the salted hash of the identification number and the nonce; and
wherein the step of attempting decryption of the user action message includes attempting decrypting, on the authentication server, the encrypted user response using the derived authentication server key and confirming the authentication if the decrypted user response is a valid response to the authentication request message including correct entry of the identification number corresponding to the salted hash stored on the authentication server.

13. The method for using a mobile device connected to a security device to authenticate a user to a service provider of claim 12 wherein the information received from the authentication request that is used in the deriving the key is one or more elements selected from the set that includes the elements a nonce, a salt, a pepper.
